(19) United States
(12) Patent Application Publication
(10) Pub. No.: US 2026/0365535 A1
(43) Pub. Date: Nov. 19, 2026

(54) Cathode material for aqueous zinc battery based on vanadium oxide and a method of preparing cathode material using plasma

(71) Applicant: Korea Institute of Energy Technology, Naju-si, Jeollanam-do (KR)

(72) Inventors: Dong Han SEO, Naju-si (KR); Sun Woo KIM, Naju-si (KR); So Young LEE, Jeollanam-do (KR); Seon Woo CHOI, Busan (KR); Tae Yong LEE, Naju-si (KR); Ali Mahmoud Mohamed Abouelanwar, Naju-si (KR); Suk Won YUN, Gimpo-si (KR); Seo Jun KIM, Daegu (KR)

(21) Appl. No.: 19/361,043

(22) Filed: Oct. 17, 2025

(30) Foreign Application Priority Data
May 13, 2025 (KR) 10-2025-0061744

(51) Int. Cl. C01G 31/02; H01M 10/36

(52) U.S. Cl. CPC C01G 31/02; H01M 10/36; C01P 2002/72; C01P 2002/82; C01P 2002/85; C01P 2002/88; C01P 2004/03; C01P 2004/04; C01P 2006/40

(57) ABSTRACT

The present invention relates to a cathode material for an aqueous zinc battery based on vanadium oxide and a method for preparing the cathode material using plasma, and more specifically, to a method for synthesizing a cathode material using a low-temperature liquid plasma and a cathode material for an aqueous zinc battery including a multilayer structure in which nanosheets of vanadium oxide are stacked and a buffer layer in which water and an alkali metal are bonded between the layer structures.

### CROSS-REFERENCE TO RELATED APPLICATION

This application claims priority to Korean Patent Application No. 10-2025-0061744, filed on May 13, 2025, and all the benefits accruing therefrom under 35 U.S.C. §119, the contents of which in its entirety are herein incorporated by reference.

### BACKGROUND

### 1. Field

The present invention relates to a cathode material for an aqueous zinc battery based on vanadium oxide and a method of preparing the cathode material using plasma, and more specifically, to a cathode material for an aqueous zinc battery synthesized in a short time by using a low-temperature liquid plasma, wherein the synthesized cathode material has a multilayer structure in which nanosheets of vanadium oxide are stacked and a buffer layer formed by the bonding of water and an alkali metal between the layer structures.

### 2. Description of the Related Art

With the increase in demand for sustainable energy, interest in next-generation energy storage devices with high safety and high power characteristics is increasing. Among them, the aqueous zinc-ion battery (AZIB) uses an aqueous solution as an electrolyte, thereby having the advantages of a lower risk of fire and explosion, lower manufacturing cost, and excellent environmental friendliness compared to conventional lithium-ion batteries based on organic electrolytes.

An aqueous zinc battery uses metallic zinc (Zn) as an anode, and generally uses an aqueous solution of zinc sulfate (ZnSO₄) as an electrolyte. During the charging and discharging processes, zinc repeatedly intercalates and deintercalates in an ionic form (Zn²⁺) between the cathode and the anode. This system is considered a promising candidate for next-generation secondary batteries based on advantages such as high ionic conductivity, abundance of materials, and electrochemical stability.

In conventional aqueous zinc batteries, manganese oxide-based materials (MnO₂, Mn₃O₄, etc.), vanadium oxide-based materials (V₂O₅, VO₂, etc.), or Prussian Blue Analogues (PBA) are mainly used as cathode materials. These materials have a layered or porous structure that allows for the intercalation/deintercalation of zinc ions, and can induce relatively stable electrochemical reactions in an aqueous environment.

However, said cathode materials cause problems such as shortened lifespan and irreversible capacity reduction due to crystal structure collapse, loss of active material due to dissolution, and low electronic conductivity during repeated charging and discharging processes. In addition, reactivity with the aqueous electrolyte increases the instability of the electrode/electrolyte interface, which leads to a decrease in the overall performance of the battery.

Therefore, for the commercialization of aqueous zinc batteries, there is a need to develop a method for synthesizing a cathode material that has excellent electrochemical and structural stability in an aqueous environment, and has a high reversible capacity and a long lifespan.

### REFERENCES

1. Korean Patent No. 10-2665679

2. Korean Patent Publication No. 10-2019-0097781

### SUMMARY

An object of the present invention is to provide a cathode material having excellent electrochemical and structural stability, high capacity and long lifespan, and a method for synthesizing the same.

To achieve the above object, the present invention provides a cathode material for an aqueous zinc battery, comprising: a plurality of vanadium oxide nanosheets stacked in a sheet form; and a buffer layer in which water and an alkali metal are bonded between the layers of the stacked nanosheets; wherein the alkali metal is K or Na.

In addition, the present invention provides a method for preparing a cathode material for an aqueous zinc battery, comprising: (A) a step of mixing and dispersing a vanadium precursor and an alkali metal precursor in distilled water; (B) a step of applying plasma to the dispersed solution; (C) a step of heating the plasma-treated solution; and (D) a step of obtaining, washing, and drying a precipitate after the heating.

The method for synthesizing a cathode material according to the present invention can maximize energy efficiency with significantly reduced temperature conditions and time compared to the prior art, thereby synthesizing a cathode material with excellent performance.

In addition, the synthesized cathode material exhibits excellent stability by maintaining a high capacity during charging and discharging regardless of current density, and may have the effect of increasing the lifespan of the aqueous zinc battery.

However, the effects of the present invention are not limited to those mentioned above, and other unmentioned effects will be clearly understood by those skilled in the art from the description below.

### BRIEF DESCRIPTION OF THE DRAWINGS

FIG. 1 is an image showing a process of synthesizing a vanadium oxide-based cathode material.

FIG. 2 shows a thermal image and a graph measuring the temperature change of a reactor during a plasma treatment process.

FIG. 3 is a graph showing the results of XRD analysis of the cathode material according to the present invention.

FIG. 4 is a graph showing the results of Raman analysis of the cathode material according to the present invention.

FIG. 5 is a graph showing the results of TGA analysis of the cathode material according to the present invention.

FIG. 6 is a graph showing the results of XPS analysis of the cathode material according to the present invention.

FIG. 7 is a graph showing the results of FT-IR analysis of the cathode material according to the present invention.

FIG. 8 is an image showing the cathode material according to the present invention analyzed by SEM and EDS.

FIG. 9 is an image showing the cathode material according to the present invention analyzed by TEM.

FIG. 10 is a graph showing the analysis results of the charge-discharge performance of the cathode material according to the present invention.

FIG. 11 is a graph showing the analysis results of the long-cycle charge-discharge performance of the cathode material according to the present invention.

### DETAILED DESCRIPTION

Hereinafter, the present invention will be described in detail with reference to the drawings.

One aspect of the present invention relates to a cathode material for an aqueous zinc battery, and relates to a cathode material having a multilayer structure in which a plurality of vanadium oxide-based nanosheets are stacked.

The cathode material for an aqueous zinc battery of the present invention may be configured to include: a plurality of vanadium oxide nanosheets stacked in a sheet form; and a buffer layer in which water and an alkali metal are bonded between the layers of the stacked nanosheets.

At this time, the alkali metal may be potassium (K) or sodium (Na). It is preferable to include K or Na as the alkali metal because a high theoretical capacity can be achieved, and it may be more preferable to use K because a slightly higher capacity is achieved than Na.

In addition, in the present invention, the vanadium oxide may be V₂O₅. That is, the cathode material of the present invention has a structure in which a plurality of nanosheets of V₂O₅ are stacked, and may include a buffer layer formed by the bonding of water and an alkali metal between the nanosheet layers.

Vanadium oxide-based cathode materials mainly used in aqueous zinc batteries have the advantage of high capacity according to the number of oxides, but have problems such as elution of the cathode material into the electrolyte due to low stability, performance degradation during long-cycle charging and discharging, and capacity degradation due to a low zinc ion diffusion rate during high-power charging and discharging.

To solve these problems, the cathode material for an aqueous zinc battery of the present invention can provide a vanadium oxide-based cathode material for an aqueous zinc battery that includes V₂O₅ in the form of a 3D nanosheet with structural stability and a buffer layer in which water and an alkali metal are bonded inside the V₂O₅ structure.

The cathode material of the present invention includes a buffer layer between the stacked nanosheets, thereby widening the interlayer distance of the stacked nanosheets, and the widened interlayer distance serves as a pathway for zinc ions to diffuse smoothly into the cathode material, thereby achieving excellent performance of the aqueous zinc battery.

In addition, the buffer layer formed inside the layered structure by the bonding of water and an alkali metal alleviates the deintercalation/intercalation reaction of zinc ions, thereby preventing the collapse of the internal structure of the cathode material during charging and discharging and preventing its elution into the electrolyte, which can increase long-term stability.

In the present invention, the interlayer distance between the stacked nanosheet layers may be 0.5 to 1.5 nm, and more preferably 0.7 to 1.3 nm. Since the size of a zinc ion is 0.44 nm, the interlayer distance must be greater than that for smooth diffusion, and if it exceeds 1.5 nm, the interlayer space becomes excessively wide, which reduces structural stability and is thus not preferable.

In particular, the cathode material of the present invention can dramatically improve the energy efficiency of the cathode material synthesis process in terms of time and temperature by utilizing low-temperature liquid plasma technology.

The cathode material of the present invention can be synthesized by performing two steps: i) a plasma treatment step; and ii) a hydrothermal annealing step.

Specifically, vanadium oxide can be rapidly prepared by treating a vanadium precursor in a hydrothermal environment with plasma, and then heated as is for heat treatment. In the heat treatment process after the plasma treatment, the size of the vanadium oxide nanosheets increases & thickens and finally form V₂O₅ in a 3D nanosheet clusters with structural stability, and a cathode material in which water and an alkali metal are bonded within the V₂O₅ structure can be synthesized.

Plasma is a state in which gas is ionized by high temperature or high voltage, with electrons and ions intermingled. The cathode material of the present invention synthesized using plasma technology allows for uniform oxidation of vanadium in a short time and can create a unique crystal structure, thereby obtaining the effect of significantly improved performance, particularly the lifespan and capacity, of the aqueous zinc battery.

Another aspect of the present invention relates to a cathode comprising the cathode material for an aqueous zinc battery of the present invention.

In addition, another aspect of the present invention relates to an aqueous zinc battery comprising: a cathode for an aqueous zinc battery according to the present invention; an anode comprising zinc (Zn); a separator interposed between the cathode and the anode; and an electrolyte.

Another aspect of the present invention relates to a method for preparing a cathode material for an aqueous zinc battery using a low-temperature liquid plasma.

More specifically, it may comprise: (A) a step of mixing and dispersing a vanadium precursor and an alkali metal precursor in distilled water; (B) a step of applying plasma to the dispersed solution; (C) a step of heating the plasma-treated solution; and (D) a step of obtaining, washing, and drying a precipitate after the heating.

The method for synthesizing a cathode material using the low-temperature liquid plasma of the present invention can overcome the major drawbacks of the sol-gel and hydrothermal synthesis methods of the prior art, which are long synthesis times of about 12-48 hours and high temperatures of about 200-500° C, thereby enabling the synthesize of a cathode material with excellent performance in a low-temperature environment in a short time.

The significantly lower temperature and synthesis time compared to the prior art maximize the energy efficiency of the process, and the synthesized cathode material can achieve excellent performance, showing a higher capacity (400-600 mAh/g) compared to conventional cathode active materials (200-300 mAh/g).

Hereinafter, the method for preparing a cathode material using plasma of the present invention will be described in detail.

Step (A) of the present invention is a step of preparing a dispersion including a vanadium precursor and an alkali metal precursor, which can preferably be dispersed in a reactor containing distilled water.

In the present invention, the vanadium precursor may be one or more selected from the group consisting of VCl₃, VOSO₄, VOCl₃, NH₄VO₃, and mixtures thereof. Preferably, VCl3 may be used.

In the present invention, the alkali metal precursor may be KOH or NaOH.

The vanadium precursor and the alkali metal precursor of the present invention can preferably be introduced into the reactor in the form of an aqueous solution, and the concentration of the aqueous solution may be 0.01 to 5 M.

Step (B) of the present invention is a step of applying plasma to the dispersion containing the vanadium precursor and the alkali metal precursor, wherein a liquid plasma, which is generated directly inside or on the surface of the liquid of the dispersion, can be applied for a certain period of time.

In the liquid plasma of the present invention, although the temperature of the plasma gas itself is very high, the temperature of the entire liquid to which the plasma is applied is maintained at a low temperature, and specifically, a low-temperature environment of less than 100° C can be consistently maintained.

In addition, the liquid plasma used in the present invention does not require high temperature or high pressure, enables the synthesis of metal oxides without catalysts or reducing agents, and can achieve the effect of inducing a fast reaction. Furthermore, it is a low-cost and environmentally friendly technology that may have high potential for application in various industrial fields.

In the present invention, the plasma may be an air plasma applied at atmospheric pressure.

Air plasma is a plasma created by ionizing nitrogen (N₂), oxygen (O₂), water vapor (H₂O), etc., in the atmosphere. It can be inexpensive and simple because it generates plasma using the surrounding air without injecting a separate gas. The method for generating the plasma is not particularly limited as long as it is a conventional method in the art, and for example, radio frequency (RF) plasma, microwave plasma, atmospheric pressure plasma, etc., can be used.

Step (C) of the present invention is a hydrothermal synthesis step, in which the vanadium oxide synthesized by the plasma treatment is annealed by heating it to a certain temperature to increase the particle size and to convert all unreacted materials.

By performing a hydrothermal synthesis process of heating the reactor after the plasma treatment, the effect of significantly increasing the structural stability of the layered structure in which the synthesized vanadium oxide nanosheets are stacked can be obtained.

In the present invention, the heating temperature in step (C) may be 100 to 300° C.

The vanadium oxide V₂O₅ synthesized by the manufacturing method of the present invention may undergo phase transition or oxygen loss at a temperature of about 400° C or higher, so the temperature condition of the present invention, not exceeding 300° C, can be said to be suitable.

In addition, if the heating temperature is less than 100° C, the annealing effect of vanadium oxide cannot be obtained, and if it exceeds 300° C, the effect of improving energy efficiency cannot be obtained, which is not preferable.

Step (D) of the present invention is a step of obtaining the finally synthesized vanadium oxide-based cathode material, in which the cathode material can be finally obtained by performing filtration-washing-drying processes.

According to a preferred embodiment, after the reaction is completed, the precipitated brown powder can be filtered, washed several times with water and ethanol, and then completely dried in an oven at 100° C or lower.

Although not explicitly stated in the Examples below, as a result of checking while varying the precursors and synthesis conditions used in the cathode material synthesis process, it was found that, unlike other conditions, when all of the following conditions were satisfied, the capacity of the cathode material was maintained at 95 % or more during charging and discharging regardless of the current density, and the effect of maintaining 90 % or more even during long-cycle charging and discharging was shown.

In particular, the total process time for the cathode material synthesis was less than 70 minutes, which is a remarkably short time compared to the prior art, showing the effect of being able to synthesize a cathode material with excellent performance in a short time.

Looking at the conditions, the vanadium precursor is VCl₃, the alkali metal precursor is KOH or NaOH introduced as a 1 M aqueous solution, the plasma is air plasma applied at atmospheric pressure for 10 minutes, and step (C) may be characterized by heating to 200° C.

Hereinafter, preferred examples are presented to aid in the understanding of the present invention. However, these examples are for more specific explanation of the present invention, and it will be apparent to those of ordinary skill in the art that various changes and modifications are possible within the scope and technical spirit of the present invention, without the scope of the present invention being limited thereby.

### EXAMPLES

### Example 1. Synthesis of cathode material with water and K bonded to V₂O₅

0.8 g of vanadium precursor VCl₃ was dispersed in water, and after adding 12 ml of 1 M KOH to the dispersion (brown) and mixing, it was dispersed. The mixed dispersion was placed on a hot plate set to 200° C, and then air plasma was applied at atmospheric pressure for 10 minutes. While applying the plasma for 10 minutes, the brown dispersion turned yellow, and the synthesized powder precipitated to the bottom. The plasma-treated mixed solution was boiled at 200° C for 1 hour to complete the reaction of unreacted vanadium ions. The supernatant of the reaction-completed mixed solution became transparent, and V₂O₅ powder (brown) with K⁺ and water bonded was formed and precipitated at the bottom.

The precipitated brown powder was obtained, washed several times with water and ethanol, and then completely dried in an oven at 80 °C. The finally obtained cathode material was named K⁺@water/V₂O₅.

### Example 2. Synthesis of cathode material with water and Na bonded to V₂O₅

The synthesis was carried out in the same manner as in Example 1, except that 12 ml of 1 M NaOH was added and mixed with the dispersion (brown) instead of adding 12 ml of 1 M KOH and mixing in Example 1. The finally obtained cathode material was named Na⁺@water/V₂O₅.

### Experimental Example 1. Measurement of temperature change during cathode material synthesis process

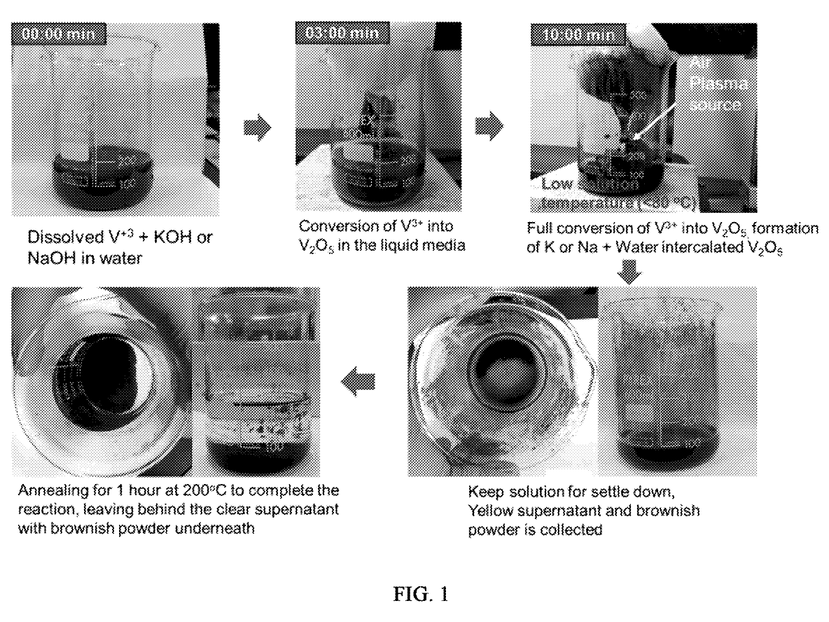

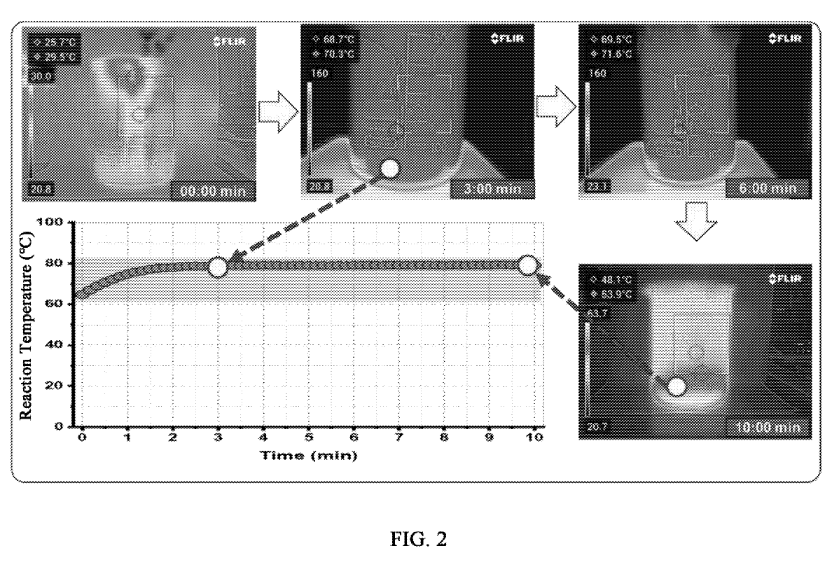

The synthesis process and temperature change of the vanadium-based cathode material prepared according to the example of the present invention are shown in FIGS. 1-2.

FIG. 1 is an image showing the synthesis process of a vanadium-based cathode material according to an example of the present invention.

FIG. 2 shows a thermal image and a graph measuring the internal temperature change of the reactor during the plasma treatment process in the synthesis of the cathode material according to an example of the present invention.

Referring to FIGS. 1 and 2, when plasma was applied to the hydrothermal reactor, the brown reactant precipitated within 10 minutes, and it can be confirmed that the temperature of the mixed solution inside the reactor was maintained at about 80° C and did not exceed 100° C, which is a low-temperature environment.

Therefore, through Experimental Example 1, it can be seen that in the cathode material synthesis process of the present invention, where the plasma treatment step and the hydrothermal annealing step are integrated, the vanadium precursor is converted in a short time in a low-temperature environment, allowing the cathode material to be synthesized.

### Experimental Example 2. Structural analysis of vanadium oxide-based cathode material

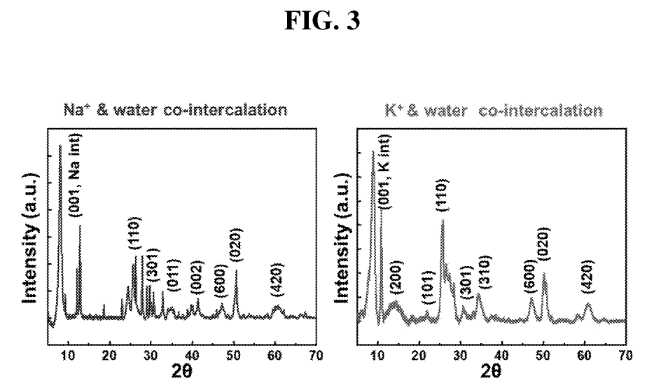

In order to analyze the structure and properties of the vanadium-based cathode material prepared according to the example of the present invention, XRD, Raman, TGA, XPS, and FTIR analyses were performed and are shown in FIGS. 3 - 7.

FIG. 3 is a graph showing the results of XRD analysis of Examples 1 and 2 of the present invention.

Referring to FIG. 3, it can be seen that the V₂O₅ cathode material with an alkali metal and water bonded according to Examples 1 and 2 exhibits a large interlayer distance through the (001) peak of V₂O₅.nH₂O (θ<10) and a alkali metal-V₂O₅ peaks (10<θ<15). In addition, it shows a mixture of V₂O₅.nH₂O & alkali-metal-V₂O₅ crystal structure, and since the peak intensity and width are not significant, it can be confirmed that the crystallinity is well maintained.

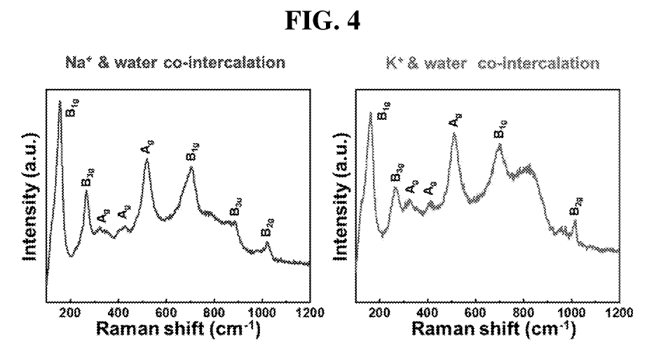

FIG. 4 is a graph showing the results of Raman analysis of Examples 1 and 2 of the present invention.

Referring to FIG. 4, the V₂O₅ cathode materials with alkali metal and water bonded, both Na⁺@water/V₂O₅ and K⁺@water/V₂O₅, show similar vibration modes, and since a peak broadening phenomenon was observed in the graph of K⁺@water/V₂O₅, it can be confirmed that structural flexibility increased and the interlayer distance was expanded compared to Na⁺@water/V₂O₅.

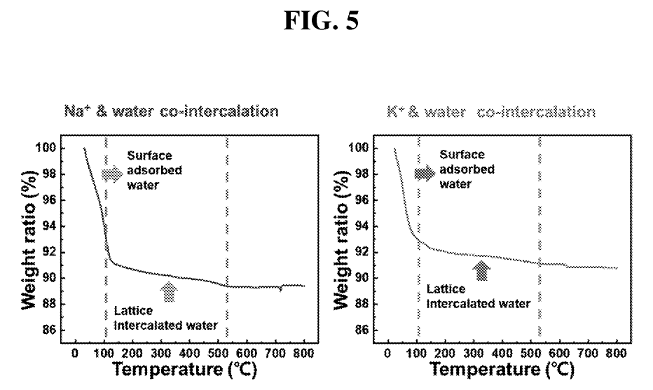

FIG. 5 is a graph showing the results of TGA analysis of Examples 1 and 2 of the present invention.

Referring to FIG. 5, it can be confirmed that about 7-8 % of moisture is present on the surface of the V₂O₅ cathode material with alkali metal and water bonded, and 2-3 % of water is present within the crystal structure.

In addition, it can be confirmed that for both V₂O₅ cathode materials with alkali metal and water bonded, removal of surface-adsorbed water occurs below 100° C, and removal of water inserted into the lattice occurs at 100-500° C. Compared to Na⁺@water/V₂O₅, K⁺@water/V₂O₅ has a smaller overall weight loss, and the desorption of water proceeds relatively quickly, so it can be confirmed that K⁺@water/V₂O₅ has a more stable structure.

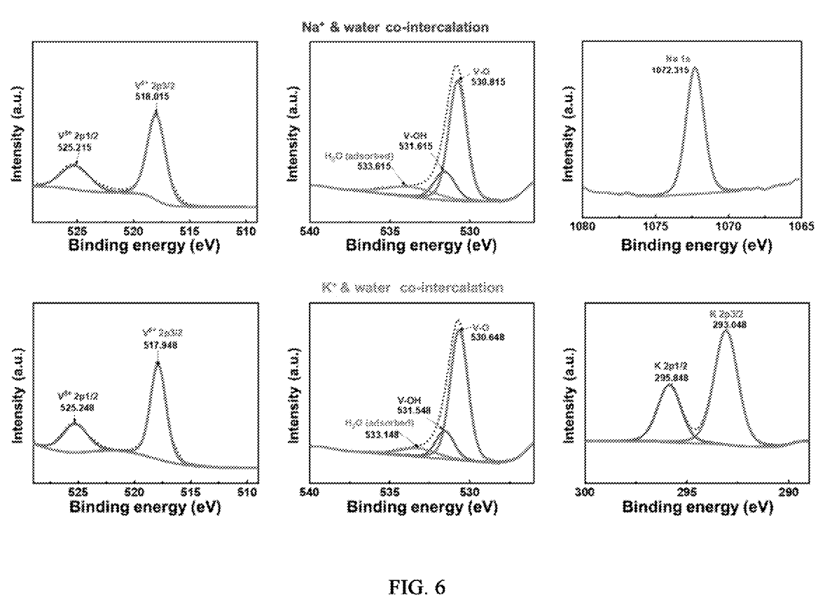

FIG. 6 is a graph showing the results of XPS analysis of Examples 1 and 2 of the present invention.

Referring to FIG. 6, it can be confirmed that the V₂O₅cathode material with alkali metal and water bonded has a form in which water and the alkali metal K or Na are successfully bonded with V₂O₅, and both K⁺@water/V₂O₅ and Na⁺@water/V₂O₅ have a V⁵⁺/V⁴⁺ mixed oxidation states and various oxygen bonding forms (V-O, V-OH, H₂O).

In particular, since K⁺@water/V₂O₅ has a relatively weak peak for adsorbed water (H₂O), it can be confirmed that it has a more stable and robust structure.

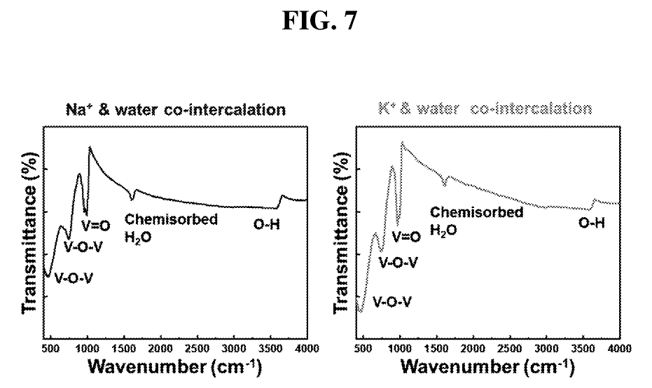

FIG. 7 is a graph showing the results of FT-IR analysis of Examples 1 and 2 of the present invention.

Referring to FIG. 7, since peaks for V-O-V and V=O appear in both V₂O₅ cathode materials with alkali metal and water bonded, it can be confirmed that the structure of V₂O₅ is maintained, and since peaks for H₂O and O-H appear, it can also be confirmed that water and V₂O₅ are chemically bonded.

In particular, since the peak for water (H₂O) appears weaker in K⁺@water/V₂O₅ compared to Na⁺@water/V₂O₅, it can be confirmed that it has a relatively more stable structure.

Therefore, through Experimental Example 2, it can be seen that the V₂O₅ cathode material with alkali metal and water bonded, synthesized according to the present invention, shows a wide interlayer distance between the nanosheets and that water-V₂O₅ & alkali metals-V₂O₅ are chemically bonded.

The wide interlayer distance between the nanosheets contributes to improving the ion diffusion path for zinc ions to smoothly diffuse into the cathode material, and the water present between the nanosheet layers can play a role in providing a path that enhances the mobility of ions, thereby achieving excellent secondary battery performance.

### Experimental Example 3. Morphological analysis of vanadium oxide-based cathode material

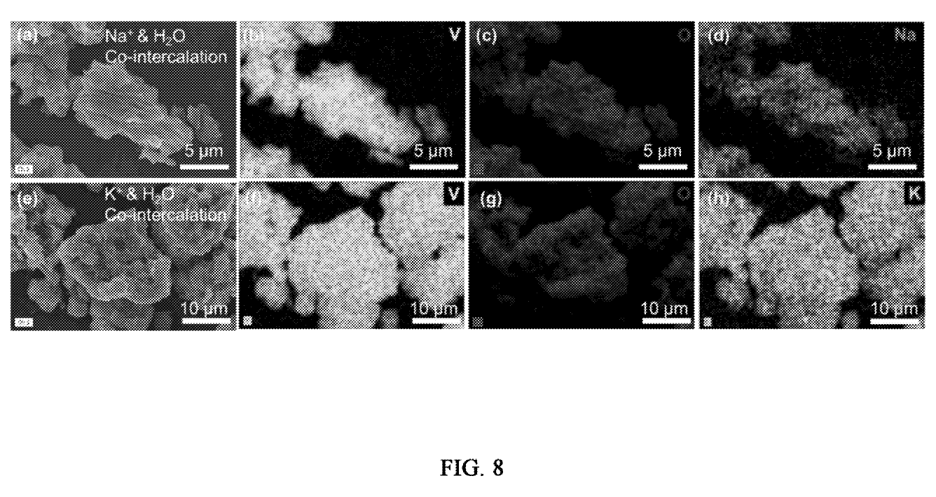

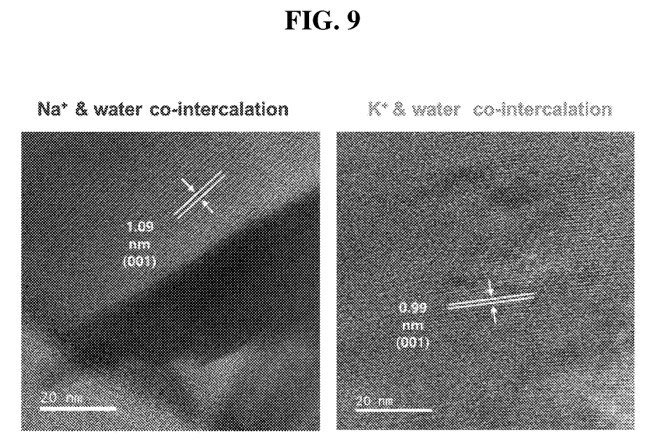

In order to analyze the morphology of the vanadium-based cathode material prepared according to the example of the present invention, SEM, EDS, and TEM analyses were performed and are shown in FIGS. 8-9.

FIG. 8 is an image showing the analysis of Examples 1 and 2 of the present invention by SEM and EDS.

Referring to FIG. 8, it can be confirmed through SEM analysis that the V₂O₅ cathode material with K or Na and water bonded exhibits a 3D structure of a nanosheet form. In addition, it can be confirmed through EDS analysis that the alkali metal K or Na is uniformly bonded and distributed within the cathode material.

FIG. 9 is an image showing the analysis of Examples 1 and 2 of the present invention by TEM.

Referring to FIG. 9, it can be confirmed that the V₂O₅ cathode material with K or Na and water bonded has a layered structure showing a wide interlayer distance that facilitates the diffusion of zinc ions, which have a size of approximately 0.44 nm. Specifically, the interlayers of Na⁺@water/V₂O₅ and K⁺@water/V₂O₅ are 1.09 nm and 0.99 nm, respectively, so zinc ions of 0.44 nm can easily diffuse.

Therefore, through Experimental Example 3, it can be seen that the V₂O₅ cathode material with K or Na and water bonded has a wide interlayer structure between the vanadium-based nanosheets, and since the interlayer distance is wider than the size of zinc ions, the diffusion of zinc ions is easy.

### Experimental Example 4. Evaluation of electrochemical properties

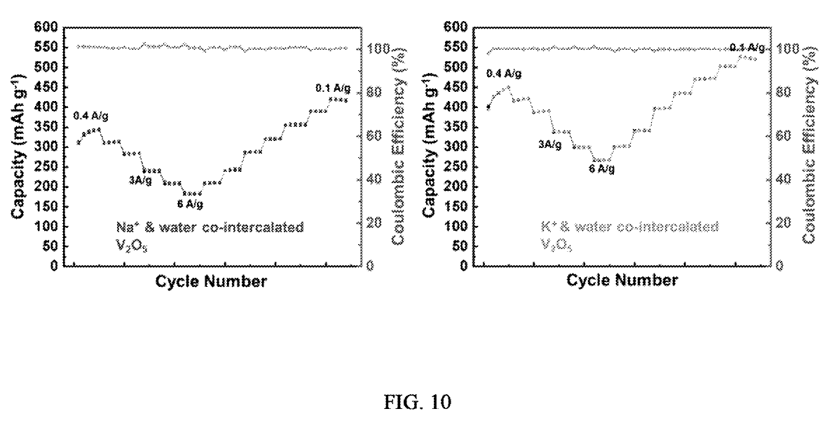

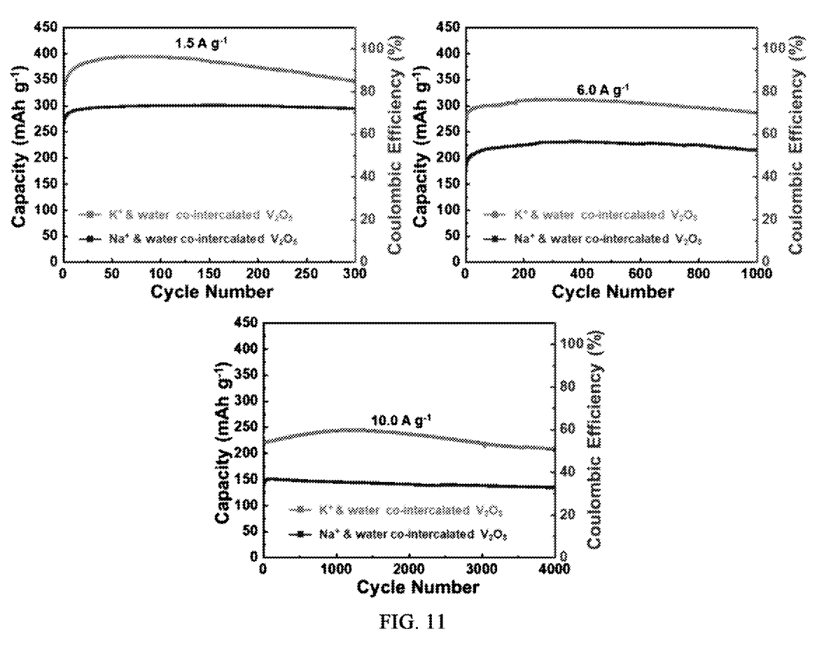

An electrochemical evaluation of an aqueous zinc battery including the vanadium-based cathode material prepared according to the example of the present invention was conducted, and the results are shown in FIGS. 10 and 11.

A cathode slurry was prepared by mixing the V₂O₅ cathode material with alkali metal and water bonded, prepared in the example of the present invention, Super C based on carbon as a conductive agent, and a binder solution in which PVDF was dissolved in an NMP solvent at 10 wt%, in a weight ratio of active material : conductive agent : binder = 7 : 2 : 1, and mixing with a mixer. The cathode slurry was coated on a Ti metal foil at 3.5 mg/cm², and then the NMP solvent was completely removed by drying in an 80 °C oven. A coin cell (CR2032) was assembled using the prepared Ti foil coated with the V₂O₅ electrode active material as a cathode, a glass fiber separator as a separator, a Zn metal foil as an anode, and ZnOTF₂ as an electrolyte. The assembled coin cell was rested for 12 hours at room temperature, and then a half-cell was prepared to proceed with charging and discharging.

FIG. 10 is a graph showing the results of analyzing the charge-discharge performance of Examples 1 and 2 of the present invention.

Referring to FIG. 10, when the performance of the V₂O₅ cathode material with K or Na and water bonded was analyzed for charging and discharging at low (1.5 Ag⁻¹), medium (6.0 Ag⁻¹), and high (10.0 Ag⁻¹) current densities, it can be confirmed that it shows high storage capacity and excellent cycle stability at all current densities. In addition, since both K⁺@water/V₂O₅ and Na⁺@water/V₂O₅ show high coulombic efficiency, it can be confirmed that there is almost no loss during the charging and discharging processes.

In particular, it can be confirmed that K⁺@water/V₂O₅ maintains a high capacity of about 200-230 mAhg⁻¹ even at a high current density of 10.0 Ag⁻¹, and shows a high coulombic efficiency of about 95 % or more under all conditions.

FIG. 11 is a graph showing the results of analyzing the long-cycle charge-discharge performance of Examples 1 and 2 of the present invention.

Referring to FIG. 11, it can be confirmed that the V₂O₅ cathode material with K or Na and water bonded shows the performance of maintaining excellent storage capacity at all current densities and a long lifespan. In addition, it can be confirmed that both K⁺@water/V₂O₅ and Na⁺@water/V₂O₅ show a high coulombic efficiency close to about 100 %.

Regarding long-term cycle life, K⁺@water/V₂O₅ was confirmed to exhibit slightly better performance than Na⁺@water/V₂O₅, the latter of which was maintained for over 4000 cycles.

Therefore, through Experimental Example 4, it can be seen that the wide interlayer structure of the cathode material due to the insertion of Water & K or Na ions in the V₂O₅ structure improves the crystal structure stabilization and zinc ion mobility of the cathode material, so that an aqueous zinc battery including the cathode material of the present invention can achieve excellent performance.

In summary, according to the analysis results of the experimental examples described above, the method for synthesizing a cathode material for an aqueous zinc battery of the present invention using plasma can maximize the energy efficiency of the process by synthesizing a cathode material with excellent performance in a short time of less than 70 minutes in a low-temperature environment not exceeding 300° C.

In addition, it can be seen that the cathode material synthesized according to the present invention can achieve excellent performance as a buffer layer with water and an alkali metal bonded is formed between the stacked vanadium oxide nanosheets, thereby increasing structural stability and significantly improving capacity and lifespan.

Although the embodiments of the present invention have been described above, those skilled in the art will be able to variously modify and change the present invention by adding, changing, deleting, or adding components without departing from the spirit of the present invention described in the claims, and this will also be included within the scope of rights of the present invention.

What is claimed is:

1. A cathode material for an aqueous zinc battery, comprising:
a plurality of vanadium oxide nanosheets stacked in a sheet form; and
a buffer layer in which water and an alkali metal are bonded, the buffer layer being located between the layers of the stacked nanosheets;
wherein the alkali metal is K or Na.

2. The cathode material for an aqueous zinc battery of claim 1, wherein the vanadium oxide is V₂O₅.

3. The cathode material for an aqueous zinc battery of claim 1, wherein an interlayer distance of the nanosheets is 0.5 to 1.5 nm.

4. The cathode material for an aqueous zinc battery of claim 1, wherein the cathode material is prepared by performing two steps of: i) a plasma treatment step; and ii) a hydrothermal annealing step.

5. A cathode for an aqueous zinc battery comprising the cathode material of claim 1.

6. An aqueous zinc battery comprising:
the cathode for an aqueous zinc battery of claim 5;
an anode comprising zinc (Zn);
a separator interposed between the cathode and the anode; and
an electrolyte.

7. A method for preparing a cathode material for an aqueous zinc battery, comprising:
(A) a step of mixing and dispersing a vanadium precursor and an alkali metal precursor in distilled water;
(B) a step of applying plasma to the dispersed solution;
(C) a step of heating the plasma-treated solution;
(D) a step of obtaining, washing, and drying a precipitate after the heating.

8. The method for preparing a cathode material for an aqueous zinc battery of claim 7, wherein the vanadium precursor is one or more selected from the group consisting of VCl₃ VOCl₃ VOSO₄ NH₄VO₃ and mixtures thereof.

9. The method for preparing a cathode material for an aqueous zinc battery of claim 7, wherein the alkali metal precursor is KOH or NaOH.

10. The method for preparing a cathode material for an aqueous zinc battery of claim 7, wherein the plasma is an air plasma applied at atmospheric pressure.

11. The method for preparing a cathode material for an aqueous zinc battery of claim 7, wherein the step (C) is characterized by heating to 100 to 300° C.

12. The method for preparing a cathode material for an aqueous zinc battery of claim 7, wherein
the vanadium precursor is VCl₃
the alkali metal precursor is KOH or NaOH introduced as a 1 M aqueous solution,
the plasma is an air plasma applied at atmospheric pressure for 10~20 minutes, and
the step (C) is characterized by heating to 200° C.
